(19) United States
(12) Patent Application Publication
(10) Pub. No.: US 2011/0065891 A1
(43) Pub. Date: Mar. 17, 2011

(54) POLYTHIOETHERIMIDES AND METHOD FOR PRODUCING THEREOF

(75) Inventors: Xingzhong Fang, Ningbo (CN); Benlin Hu, Ningbo (CN); Ying Han, Ningbo (CN); Ji Ma, Ningbo (CN); Qing Yan, Ningbo (CN); Mengxian Ding, ChangChun (CN)

(73) Assignee: CHANGCHUN HIPOLYKING CO.,LTD., ChangChun (CN)

(21) Appl. No.: 12/809,993

(22) PCT Filed: Dec. 19, 2008
(86) PCT No.: PCT/CN2008/073592

§ 371 Date: Oct. 28, 2010

(30) Foreign Application Priority Data
Dec. 19, 2007 (CN) 200710300814.7
Mar. 14, 2008 (CN) 200810060189.8

(51) Int. Cl. C08G 69/28

(52) U.S. Cl. 528/289

(57) ABSTRACT

Polythioetherimides and a producing method thereof. The method is comprised of using monosubstituted phthalic anhydride isomer as raw material, reacting it with disubstituted amine to produce disubstituted phthalimide, allowing coupling reaction between the obtained phthalimide and an alkali metal sulfide or sulfur to produce polythioetherimides.

### TECHNICAL FIELD

The invention is directed to polythioetherimides and methods for preparing the same, in particular to methods for preparing novel polythioetherimides using chlorophthalic anhydride or nitrophthalic anhydride isomers as starting materials.

### BACKGROUND ART

Despite the superior comprehensive performances owned by polyimides, a typical class of thermally stable high molecular materials, resulting from rigid imide units present in their molecular chains, their low solubility and poor melt processability restrict their development and application. Polythioetherimides, obtained by incorporating soft units of ether bond into the rigid backbones of polyimides, are characterized by good solubility, low melt viscosity and melt processability in addition to excellent thermal mechanical properties. The best known product of this kind is the engineering plastics developed by GE under the name of Ultem. According to various methods disclosed in U.S. Pat. Nos. 3,847,867, 3,814,860, 3,850,885, 3,852,242, 3,855,178, 3,983,093, 5,830,974 and so on, polythioetherimides are generally prepared via reactions between ether-bond-containing dianhydride and diamine monomers or between ether-bond-containing diamine and dianhydride monomers. Alternatively, they can be prepared via aromatic nucleophilic substitutions between disubstituted phthalic imide monomers and salts of bisphenols. The alternative methods draw extensive attention for less steps and lower cost are required. More recently, U.S. Pat. No. 6,849,706 discloses a novel class of isomeric copolyetherimides and methods for preparing the same.

Polythioetherimides are generally prepared via reactions between dianhydrides of thioether-bond-containing aromatic tetrabasic acids and aliphatic or aromatic diamines. Due to the incorporation of soft units of thioether bond into the rigid backbones of polyimides, such polymers are characterized by good solubility, low melt viscosity and melt processability in addition to excellent thermal mechanical properties, which lead them to be promising thermoplastic high molecular materials with high thermal resistance. Therefore, it was very early when the synthesis of diphenyl thioether type tetrabasic acid dianhydrides and corresponding polythioetherimides aroused people's interest. For example, U.S. Pat. Nos. 3,989,712, 4,054,584, 4,092,297, 4,499,285 and 4,625,037 reported the synthesis of 3,3′-position diphenyl thioether dianhydride or 4,4′-position diphenyl thioether dianhydride wherein 3- or 4-nitro- (or chloro-)phthalic imide reacted with an alkali metal sulfide or hydrosulfide, such as sodium sulfide or sodium hydrosulfide, to give a corresponding intermediate, i.e. thioether bisimide, which was hydrolyzed, acidified and dehydrated to obtain the object product; CN 1081436 reported the method for preparing 3,3′-, 3,4′- or 4,4′-position diphenyl thioether tetrabasic acid and dianhydride thereof using a halogen substituted phthalic anhydride as the starting material and sulfur as the sulfurating agent; and CN1724528 reported the method for preparing 3,4′-position diphenyl thioether dianhydride using chlorophthalic anhydride as the starting material and sodium hydrosulfide as the sulfurating agent. These dianhydrides might react with diamines to give corresponding polythioetherimides. In addition, U.S. Pat. No. 4,092,297 and Poly Bull 1995, 34 287-294 reported the production of polythioetherimides via reactions between 3,3′- or 4,4′-position dinitro- (or dichloro-) phthalic imides and alkali metal sulfides such as sodium sulfide. Although these polythioetherimides have superior thermal resistance and mechanical performances, they suffer from tedious preparing procedure and relatively high cost. Furthermore, their processabilities such as melt processability and solution processability need to be improved.

### SUMMARY OF THE INVENTION

The first object of the invention is to provide a novel polythioetherimide.

The second object of the invention is to provide a novel method for preparing the polythioetherimide.

The third object of the invention is to provide an alternative method for preparing the polythioetherimide.

In the first aspect of the invention, a novel polythioetherimide of formula I is provided:

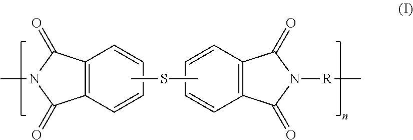

wherein thioether bond may be located at 3-position or 4-position, wherein the indicated 3-position and 4-position refer to the substitution positions of all phthalic imide rings in the polymer, wherein R is a substituted or unsubstituted organic group. The polythioetherimide obtained according to the invention exhibits excellent comprehensive performances, such as good thermal resistance, high flexibility, low melt viscosity, etc. The polymer resins are suited to be processed by injection molding, extrusion molding, press molding, solution spinning and melt spinning, and therefore their promising applications in high temperature resistant engineering plastics, thin films, adhesive agents, enameled wires, foam plastics, fibers and advanced composite materials are predictable.

In the second aspect of the invention, a method for preparing a polythioetherimide is provided, wherein chlorophthalic anhydride or nitrophthalic anhydride of formula II is used as the starting material to react with half molar equivalent of a disubstituted amine NH₂RNH₂ to give a disubstituted phthalic imide which further couples with about equal molar equivalent of an alkali metal sulfide to give a polythioetherimide resin of formula I as shown above.

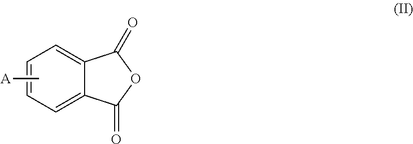

wherein substitute A is chlorine or nitro at 3- or 4-position.

In the third aspect of the invention, a method for preparing a polythioetherimide is provided, wherein chlorophthalic anhydride or nitrophthalic anhydride of the above formula II is used as the starting material to react with half molar equivalent of an organic diamine NH₂RNH₂ to give a disubstituted phthalic imide which further couples with about equal molar equivalent of sulfur to give a polythioetherimide resin of formula I as shown above.

### BRIEF DESCRIPTION OF THE DRAWINGS

FIG. 1 shows a reaction process according to one preparation method of the invention.

FIG. 2 shows a reaction process according to another preparation method of the invention.

### BEST EMBODIMENTS FOR CARRYING OUT THE INVENTION

After extensive study, the inventors have found a novel polythioetherimide and provided a method for preparing the same. Based on such findings, the invention has been completed.

Various aspects of the invention will be described in detail as follows.

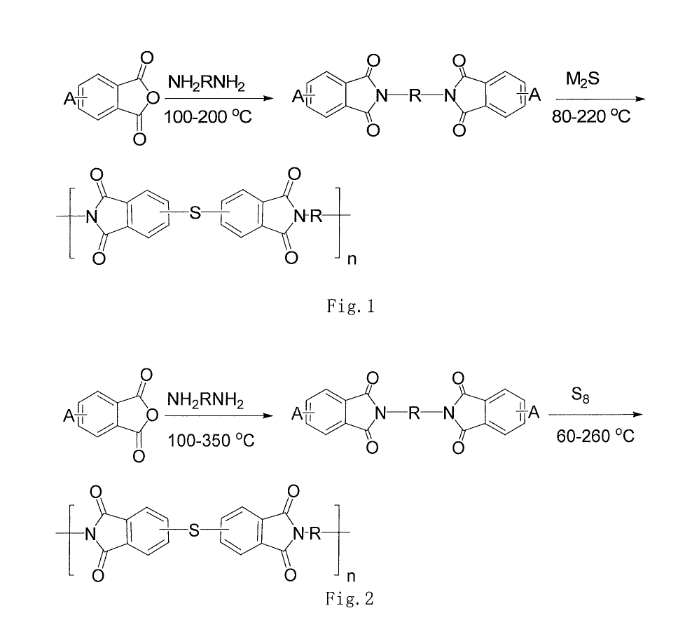

One technical method of preparation according to the invention is illustrated in FIG. 1, wherein chlorophthalic anhydride or nitrophthalic anhydride of formula II is used as the starting material to react with half molar equivalent of a disubstituted amine NH₂RNH₂ to give a disubstituted phthalic imide which further couples with about equal molar equivalent of an alkali metal sulfide to give a polythioetherimide resin of formula I as shown above.

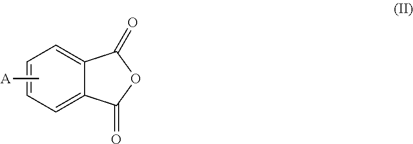

Specifically, in the starting material, i.e. chlorophthalic anhydride or nitrophthalic anhydride, the molar ratio of 3-substituted phthalic anhydride to 4-substituted phthalic anhydride is in any range between about 99.9:0.1 and about 0.1:99.9.

Specifically, the preparation method is carried out in two steps. The first step involves the reaction between chloro- (or nitro-) phthalic anhydride and half molar equivalent of an organic diamine in a polar non-protonic solvent, or in glacial acetic acid under reflux, or in a mixture of a benzene-type solvent and a polar non-protonic solvent under reflux, at a temperature ranging from 100° C. to 200° C., most preferably from 110° C. to 180° C. The second step involves the coupling of the resultant disubstituted phthalic imide with equal molar equivalent of an alkali metal sulfide in a polar non-protonic solvent, or in a mixture of a benzene-type solvent and a polar non-protonic solvent, optionally with or without the addition of certain catalysts such as sodium hydroxide, potassium hydroxide, anhydrous sodium carbonate, anhydrous potassium carbonate, or anhydrous lithium chloride, at a temperature ranging from 80° C. to 220° C., most preferably from 100° C. to 170° C.

Specifically, the polar non-protonic solvent is selected from the group consisting of N,N′-dimethyl formamide (DMF), N,N′-dimethyl acetamide (DMAc), N-methyl-2-pyrrolidone (NMP), dimethyl sulfoxide (DMSO), hexamethylphosphoramide (HMPA) and tetramethylene sulfone.

Specifically, the benzene type solvent refers to benzene, toluene, xylene or chlorobenzene.

Specifically, the alkali metal sulfide is highly pure anhydrous lithium sulfide, potassium sulfide or sodium sulfide, which is usually prepared via two methods, one involving the reaction between an alkali metal and sulfur, and the other involving the purification of an existing industrial grade alkali metal sulfide, particularly sodium sulfide, by heating at high vacuum, or by azeotropic reflux with a benzene type solvent such as benzene, toluene, xylene or chlorobenzene to remove water, or by recrystallization.

Specifically, the organic group R is a substituted or unsubstituted aliphatic or aromatic diamine selected from but not limited to, for example, at least one of the following: 1,6-hexamethylene diamine, 1,6-cyclohexanediamine, p-phenylene diamine, m-phenylene diamine, 4,4′-biphenylene diamine, 3,3′-dimethyl-4,4′-biphenylene diamine, 2,2′-dimethyl-4,4′-biphenylene diamine, 4,4′-diaminodiphenyl ether, 3,4′-diaminodiphenyl ether, 4,4′-diaminobenzophenone, 3,4′-diaminobenzophenone, 4,4′-diaminodiphenyl sulfone, 3,4′-diaminodiphenyl sulfone, 4,4′-diaminodiphenyl methane, 4,4′-diaminodiphenyl isopropane, 4,4′-diaminodiphenyl thioether, 2,2′-dichloro-4,4′-diaminodiphenyl methane, 3,3′-dichloro-4,4′-diaminodiphenyl methane, 4,4′-diaminodiphenoxyl-4″,4′″-biphenyl, 4,4′-diaminodiphenoxyl-4″,4′″-diphenyl ether, 4,4′-diaminodiphenoxyl-4″,4′″-diphenyl sulfone, 4,4′-diaminodiphenoxyl-4″,4′″-diphenyl isopropane, 2,4-toluene diamine, 5-methyl-4,6-diethyl-1,3-phenylene diamine, 3,3′-dimethyl-4,4′-diaminodiphenyl methane, or 2,2′,3,3′-tetramethyl-4,4′-diaminodiphenyl methane, or mixtures thereof.

Specifically, during the coupling of the disubstituted phthalic imide with the alkali metal sulfide, at least one chain end-capping agent for polymerization can be used to control the polymerization degree and the molecular weight of the final polymer.

Specifically, the chain end-capping agent may be an aromatic compound of formula III,

B—Ar-M III

wherein B may be selected from but not limited to halogen atoms (for example, fluorine, chlorine or bromine, etc.) or nitro, etc.; Ar is a substituted or unsubstituted aromatic group which may be selected from but not limited to one of the following: for example, phenyl, substituted phenyl, biphenyl, substituted biphenyl, furanyl, pyridyl, naphthyl or quinolyl, etc.; and M may be selected from but not limited to one of the following atoms or groups: for example, hydrogen, methyl, acyl, phenyl acyl, alkyl sulphonyl, aromatic sulphonyl, nitro, cyano, azo, carboxyl, trifluoromethyl, imido or substituted imido, etc. Examples of the chain end-capping agent include 3-chlorophenyl-tert-butyl ketone, 3-fluorophenyl-tert-butyl ketone, 4-chlorobenzophenone, 3-nitrobenzophenone, 4-nitrophenyl methyl sulfone, 4-fluorophenyl phenyl sulfone, 2-iodonitrobenzene, 4-bromophenyl azobenzene, 4-fluoropyridine, 3-chlorobenzoic acid, 1-nitro-4-trifluoromethyl benzene, 1-chloro-3-trifluoromethyl benzene, N-phenyl-3-chlorophthalic imide, N-phenyl-4-fluorophthalic imide, N-methyl-3-chlorophthalic imide, N-methyl-4-nitrophthalic imide, N-butyl-3-chlorophthalic imide, or N-cyclohexyl-4-chlorophthalic imide, etc., or mixtures of two or more thereof, wherein the most preferred molar amount of the chain end-capping agent used is about 0.01-0.15 times that of the corresponding disubstituted phthalic imide.

Another technical method of preparation according to the invention is illustrated in FIG. 2, wherein chlorophthalic anhydride or nitrophthalic anhydride of the above formula II is used as the starting material to react with half molar equivalent of an organic diamine NH₂RNH₂ to give a disubstituted phthalic imide which further couples with about equal molar equivalent of sulfur to give a polythioetherimide resin of formula I as shown above.

Specifically, in the starting material, i.e. chlorophthalic anhydride or nitrophthalic anhydride, the molar ratio of 3-substituted phthalic anhydride to 4-substituted phthalic anhydride is in any range between about 99.9:0.1 and about 0.1:99.9.

Specifically, the preparation method is carried out in two steps. The first step involves the reaction between a monosubstituted phthalic anhydride and half molar equivalent of an organic diamine in a polar non-protonic solvent, or in glacial acetic acid under reflux, or in a mixture of a benzene-type solvent and a polar non-protonic solvent under reflux, or in molten state under heating, at a temperature ranging from 100° C. to 350° C., most preferably from 120° C. to 280° C., to prepare a disubstituted phthalic imide. The second step involves the coupling of the disubstituted phthalic imide with about equal molar equivalent of sulfur in a polar non-protonic solvent or in a mixture of a benzene-type solvent and a polar non-protonic solvent with the help of a reductant, a catalyst and a reaction aid at a temperature ranging from 60° C. to 260° C., most preferably from 100° C. to 190° C., to prepare polythioetherimide, wherein the molar amount of sulfur used is about 0.90-1.30 times, most preferably 0.95-1.15 times that of the corresponding disubstituted phthalic imide.

Specifically, the polar non-protonic solvent is selected from the group consisting of N,N-dimethyl formamide (DMF), N,N-dimethyl acetamide (DMAc), N-methyl-2-pyrrolidone (NMP), dimethyl sulfoxide (DMSO), hexamethylphosphoramide (HMPA), diphenyl sulfone, tetramethylene sulfone and the like.

Specifically, the organic group R is a substituted or unsubstituted aliphatic or aromatic diamine which may be selected from but not limited to, for example, at least one of the following: 1,2-hexanediamine, hexamethylene diamine, 1,6-cyclohexanediamine, p-phenylene diamine, m-phenylene diamine, 4,4′-biphenylene diamine, 3,3′-dimethyl-4,4′-biphenylene diamine, 2,2′-dimethyl-4,4′-biphenylene diamine, 4,4′-diaminodiphenyl ether, 3,4′-diaminodiphenyl ether, 4,4′-diaminobenzophenone, 3,4′-diaminobenzophenone, 4,4′-diaminodiphenyl sulfone, 3,4′-diaminodiphenyl sulfone, 4,4′-diaminodiphenyl methane, 4,4′-diaminodiphenyl isopropane, 4,4′-diaminodiphenyl thioether, 2,2′-dichloro-4,4′-diamino diphenyl methane, 3,3′-dichloro-4,4′-diaminodiphenyl methane, 4,4′-diaminodiphenoxyl-4″,4′″-biphenyl, 4,4′-diaminodiphenoxyl-4″,4′″-diphenyl ether, 4,4′-diaminodiphenoxyl-4″,4′″-diphenyl sulfone, 4,4′-diaminodiphenoxyl-4″,4′″-diphenyl isopropane, 2,4-toluene diamine, 5-methyl-4,6-diethyl-1,3-phenylene diamine, 3,3′-dimethyl-4,4′-diaminodiphenyl methane, or 2,2′,3,3′-tetramethyl-4,4′-diaminodiphenyl methane and the like, or mixtures thereof.

Specifically, the reductant for the coupling of the disubstituted phthalic imide with sulfur may be selected from but not limited to at least one of the following: formates (for example, sodium formate, potassium formate or lithium formate, etc.), oxalates (for example, sodium oxalate, potassium oxalate or lithium oxalate, etc.), aldehydes (for example, formaldehyde or acetaldehyde, etc.), hydrazines (for example, phenylhydrazine or hydrated hydrazine, etc.), hydroxylamine, elemental metal (for example, iron powder, aluminum powder or zinc powder, etc.), hydrides (for example, sodium hydride, calcium hydride, sodium borohydride or lithium aluminum hydride, etc.), ammonia, hydrogen and the like, or mixtures thereof. The molar amount of the reductant used is 0.2-6 times, most preferably 0.4-3 times that of sulfur.

Specifically, the aid and the catalyst for the coupling polymerization of the disubstituted phthalic imide with sulfur may be selected from but not limited to at least one of the following: carbonates (for example, lithium carbonate, sodium carbonate or potassium carbonate, etc.), hydrocarbonates (for example, sodium hydrocarbonate or potassium hydrocarbonate, etc.), phosphates (for example, sodium hydrophosphate or potassium hydrophosphate, etc.), hydrophosphates (for example, dibasic sodium phosphate or dibasic potassium phosphate, etc.), basic hydroxides (for example, potassium hydroxide, sodium hydroxide or lithium hydroxide, etc.), halides (for example, calcium chloride, sodium chloride, potassium chloride, lithium bromide, potassium fluoride or sodium iodide, etc.) and the like, or mixtures thereof. The molar amount of the aid and the catalyst used is 0.02-3 times, most preferably 0.05-1.5 times that of sulfur.

Specifically, the coupling polymerization of the disubstituted phthalic imide with sulfur may be carried out in inert atmosphere which may be selected from but not limited to nitrogen, argon and the like.

Specifically, during the coupling polymerization of the disubstituted phthalic imide and sulfur, at least one chain end-capping agent for polymerization can be used to control the polymerization degree and the molecular weight of the final polymer.

Specifically, the chain end-capping agent may be an aromatic compound of formula III,

B—Ar-M III

wherein B may be selected from but not limited to halogen atoms (for example, fluorine, chlorine or bromine, etc.) or nitro, etc.; Ar is a substituted or unsubstituted aromatic group which may be selected from but not limited to one of the following: for example, phenyl, substituted phenyl, biphenyl, substituted biphenyl, furanyl, pyridyl, naphthyl or quinolyl, etc.; and M may be selected from but not limited to one of the following atoms or groups: for example, hydrogen, methyl, acyl, phenyl acyl, alkyl sulphonyl, aromatic sulphonyl, nitro, cyano, azo, carboxyl, trifluoromethyl, imido or substituted imido, etc. Examples of the chain end-capping agent include 3-chlorophenyl-tert-butyl ketone, 3-fluorophenyl-tert-butyl ketone, 4-chlorobenzophenone, 3-nitrobenzophenone, 4-nitrophenyl methyl sulfone, 4-fluorophenyl phenyl sulfone, 2-iodonitrobenzene, 4-bromophenyl azobenzene, 4-fluoropyridine, 3-chlorobenzoic acid, 1-nitro-4-trifluoromethyl benzene, 1-chloro-3-trifluoromethyl benzene, N-phenyl-3-chlorophthalic imide, N-phenyl-4-fluorophthalic imide, N-methyl-3-chlorophthalic imide, N-methyl-4-nitrophthalic imide, N-butyl-3-chlorophthalic imide, or N-cyclohexyl-4-chlorophthalic imide, etc., or mixtures of two or more thereof, wherein the most preferred molar amount of the chain end-capping agent used is about 0.01-0.15 times that of the corresponding disubstituted phthalic imide.

The final polythioetherimides show a logarithmic viscosity number of about 0.13 dL/g-about 1.90 dL/g as measured in 0.5 g/dL m-cresol at 30° C. using Ubbelohde viscometer, and a weight average molecular weight of about 3000-about 200000 with respect to polystyrene standard and a polydispersity of about 1.8-about 5.4 as measured by gel permeation chromatography.

The final polythioetherimides show a glass transition temperature of about 200° C.-about 350° C. according to reheating data as measured by differential scanning calorimetry (DSC) using Perkin Elmer Diamond DSC in nitrogen atmosphere at a heating rate of 20° C./min.

The final polythioetherimides show a viscosity of about 500 P-about 100000 P (Poise) as measured at a temperature of 380° C. and at a speed of 1000 S⁻¹ using Physica MCR-301 rotational rheometer.

The final polythioetherimides show a film tensile strength of about 60 MPa-about 200 MPa and a break elongation of about 5%-about 40% as measured at room temperature and at a speed of 5 mm/min using Instron Model 5567 mechanical tensile tester.

The invention will be described in more detail with reference to the accompanied drawings and the following examples. It should be noted that these examples are intended only to make further illustration of the invention, and should not be construed to limit the claimed scope of the invention in any way.

### Example 1

Into a 2 L three-necked flask, dry and clean, were added 182.56 g (1.0 mol) 4-chlorophthalic anhydride and 1000 ml glacial acetic acid, and after they were dissolved under agitation, 113.16 g (0.5 mol) 3,3′-dimethyl-4,4′-diaminodiphenyl methane (DMMDA) was added. The reactants were heated to 140° C. and allowed to react for 24 hours. The reaction solution was cooled to room temperature and then transferred into 10 L water. After filtration, a filter cake was obtained as white solid, washed three times with distilled water, and vacuum dried at 120° C. to give 249.9 g crude dichloromonomer at a yield of 90%. The crude product was recrystallized with dimethyl sulfoxide for use in subsequent polymerization. In argon atmosphere, 27.77 g (0.05 mol) of the above dichloromonomer, 3.90 g (0.05 mol) anhydrous sodium sulfide, 2.000 g (0.05 mol) sodium hydroxide and 300 ml N,N′-dimethyl acetamide (DMAc) were added into a 500 ml three-necked flask which was dry and clean. The reactants were heated to 120° C. and allowed to react for 24 hours. The reaction solution was cooled to room temperature, transferred slowly into 3 L water and agitated for 5 hours. After filtration, the resultant filter cake was extracted with 50% ethanol for 12 hours. After vacuum drying at 120° C., 21.1 g polyimide was obtained as yellowish powder at a yield of 82%. IR (KBr): 3629, 2922, 1775, 1717, 1604, 1375, 742 cm⁻¹. The logarithmic viscosity number was determined to be 0.53 dL/g in 0.5 g/dL m-cresol at 30° C. The weight average molecular weight and the polydispersity with respect to polystyrene standard were determined to be 38000 and 3.4 respectively by gel permeation chromatography. The glass transition temperature was determined to be 264° C. by differential scanning calorimetry (DSC). The film tensile strength and the break elongation were determined to be 92 MPa and 17% respectively using a mechanical tensile tester.

### Example 2

Into a 2 L three-necked flask, dry and clean, were added 182.56 g (1.0 mol) of a combination of 3-chlorophthalic anhydride and 4-chlorophthalic anhydride in a mass ratio of 5:1 and 1000 ml glacial acetic acid, and after they were dissolved under agitation, 113.16 g (0.5 mol) DMMDA was added. The reactants were heated to 130° C. and allowed to react for 24 hours. The reaction solution was cooled to room temperature and then transferred into 10 L water. After filtration, a filter cake was obtained as white solid, washed three times with distilled water, and vacuum dried at 120° C. to give 236 g crude dichloromonomer at a yield of 85%. The crude product was recrystallized with a mixed solvent of DMAc and toluene (volume ratio 2:1) for use in subsequent polymerization. In nitrogen atmosphere, 27.77 g (0.05 mol) of the above dichloromonomer, 3.90 g (0.05 mol) anhydrous sodium sulfide, 6.36 g (0.06 mol) anhydrous sodium carbonate and 250 ml DMAc were added into a 500 ml three-necked flask which was dry and clean. The reactants were heated to 130° C. and allowed to react for 36 hours. The reaction solution was cooled to room temperature, transferred slowly into 2 L water and agitated for 10 hours. After filtration, the resultant filter cake was extracted with 50% ethanol for 14 hours. After vacuum drying at 120° C., 22.1 g polyimide was obtained as yellowish powder at a yield of 86%. IR (KBr): 3476, 1775, 1716, 1606, 1374, 744 cm⁻¹. The logarithmic viscosity number was determined to be 0.24 dL/g in 0.5 g/dL m-cresol at 30° C. The weight average molecular and the polydispersity weight with respect to polystyrene standard were determined to be 16000 and 2.8 respectively by gel permeation chromatography. The glass transition temperature was determined to be 272° C. by differential scanning calorimetry (DSC). The film tensile strength and the break elongation were determined to be 104 MPa and 13% respectively using a mechanical tensile tester.

### Example 3

Into a 1 L three-necked flask, dry and clean, were added 91.28 g (0.5 mol) of a combination of 3-chlorophthalic anhydride and 4-chlorophthalic anhydride in a mass ratio of 3:1 and 500 ml DMAc, and after they were dissolved under agitation, 49.56 g (0.25 mol) 4,4′-diaminodiphenyl methane (MDA) was added. The reactants were first heated to 80° C. and allowed to react for 2 hours, and then heated to 130° C. and allowed to react for 16 hours. The reaction solution was concentrated by depressurization to 200 ml and then transferred into 3 L water. After filtration, a filter cake was obtained as white solid, washed three times with distilled water, and vacuum dried at 120° C. to give 116 g crude dichloromonomer at a yield of 88%. The crude product was vacuum melted for use in subsequent polymerization. In nitrogen atmosphere, 26.37 g (0.05 mol) of the above dichloromonomer, 2.30 g (0.05 mol) anhydrous lithium sulfide and 200 ml N-methyl-2-pyrrolidone (NMP) were added into a 500 ml three-necked flask which was dry and clean. The reactants were heated to 170° C. and allowed to react for 8 hours. The reaction solution was cooled to room temperature, transferred slowly into 2 L water and agitated for 12 hours. After filtration, the resultant filter cake was extracted with 90% ethanol for 24 hours. After vacuum drying at 150° C., 21.0 g polyimide was obtained as yellowish powder at a yield of 86%. IR (KBr): 3438, 1778, 1716, 1606, 1378, 741 cm⁻¹. The logarithmic viscosity number was determined to be 0.37 dL/g in 0.5 g/dL m-cresol at 30° C. The weight average molecular weight and the polydispersity with respect to polystyrene standard were determined to be 28000 and 4.1 respectively by gel permeation chromatography. The glass transition temperature was determined to be 275° C. by differential scanning calorimetry (DSC). The viscosity was determined to be 7600 P (Poise) at a temperature of 380° C. and at a speed of 1000 S⁻¹ using Physica MCR-301 rotational rheometer. The film tensile strength and the break elongation were determined to be 85 MPa and 6% respectively using a mechanical tensile tester.

### Example 4

Into a 1 L three-necked flask, dry and clean, were added 91.28 g (0.5 mol) of a combination of 3-chlorophthalic anhydride and 4-chlorophthalic anhydride in a mass ratio of 2:1, 400 ml DMF and 50 ml toluene, and after they were dissolved under agitation, 50.06 g (0.25 mol) 4,4′-diaminodiphenyl ether (ODA) was added. The reactants were first heated to 90° C. and allowed to react for 2 hours, and then heated to 150° C. and allowed to react for 18 hours. The reaction solution was concentrated by depressurization to 150 ml and then transferred into 2 L water. After filtration, a filter cake was obtained as white solid, washed three times with distilled water, and vacuum dried at 100° C. to give 119 g crude dichloromonomer at a yield of 90%. The crude product was recrystallized with DMSO for use in subsequent polymerization. In argon atmosphere, 26.46 g (0.05 mol) of the above dichloromonomer, 2.30 g (0.05 mol) anhydrous lithium sulfide, 6.91 g (0.05 mol) anhydrous potassium carbonate and 200 ml DMSO were added into a 500 ml three-necked flask which was dry and clean. The reactants were heated to 100° C. and allowed to react for 18 hours. The reaction solution was cooled to room temperature, transferred slowly into 1 L water and agitated for 10 hours. After filtration, the resultant filter cake was extracted with 90% methanol for 24 hours. After vacuum drying at 150° C., 20.3 g polyimide was obtained as yellowish powder at a yield of 83%. IR (KBr): 3488, 1774, 1716, 1603, 1377, 742 cm⁻¹. The logarithmic viscosity number was determined to be 0.48 dL/g in 0.5 g/dL m-cresol at 30° C. The weight average molecular weight and the polydispersity with respect to polystyrene standard were determined to be 31000 and 3.9 respectively by gel permeation chromatography. The glass transition temperature was determined to be 268° C. by differential scanning calorimetry (DSC). The viscosity was determined to be 9000 P at a temperature of 380° C. and at a speed of 1000 S⁻¹ using Physica MCR-301 rotational rheometer. The film tensile strength and the break elongation were determined to be 106 MPa and 18% respectively using a mechanical tensile tester.

### Example 5

Into a 3 L three-necked flask, dry and clean, were added 273.39 g (1.5 mol) of a combination of 3-chlorophthalic anhydride and 4-chlorophthalic anhydride in a mass ratio of 1:1, 1000 ml DMAc and 1000 ml xylene, and after they were dissolved under agitation, 81.10 g (0.75 mol) p-phenylene diamine was added. The reactants were first allowed to react at 80° C. for 2 hours, and then heated to 160° C. and allowed to react for 24 hours under reflux with water removed. The reaction solution was concentrated by depressurization to about 800 ml and then transferred into 12 L water. After filtration, a filter cake was obtained, washed three times with distilled water, and vacuum dried at 100° C. to give 292 g crude dichloromonomer at a yield of 89%. The crude product was recrystallized with a mixed solvent of DMSO and toluene for use in subsequent polymerization. In argon atmosphere, 43.72 g (0.1 mol) of the above dichloromonomer, 7.80 g (0.1 mol) anhydrous sodium sulfide and 450 ml N-methyl-2-pyrrolidone (NMP) were added into a 1 L three-necked flask which was dry and clean. The reactants were heated to 160° C. and allowed to react for 30 hours. The reaction solution was cooled to room temperature, transferred slowly into 4 L water and agitated for 12 hours. After filtration, the resultant filter cake was extracted with 90% methanol for 24 hours. After vacuum drying at 120° C., 35.8 g polyimide was obtained as yellowish powder at a yield of 90%. IR (KBr): 3442, 1779, 1714, 1601, 1382, 739 cm⁻¹. The logarithmic viscosity number was determined to be 0.68 dL/g in 0.5 g/dL m-cresol at 30° C. The weight average molecular weight and the polydispersity with respect to polystyrene standard were determined to be 35000 and 3.5 respectively by gel permeation chromatography. The glass transition temperature was determined to be 296° C. by differential scanning calorimetry (DSC). The film tensile strength and the break elongation were determined to be 159 MPa and 12% respectively using a mechanical tensile tester.

### Example 6

Into a 1 L three-necked flask, dry and clean, were added 32.86 g (0.18 mol) 4-chlorophthalic anhydride, 3.65 g (0.02 mol) 3-chlorophthalic anhydride and 400 ml glacial acetic acid, and after they were dissolved under agitation, 19.83 g (0.1 mol) 4,4′-diaminodiphenyl methane was added. The reactants were heated to 140° C. and allowed to react for 24 hours under reflux. The reaction solution was cooled to room temperature. After filtration, a filter cake was obtained, washed three times with distilled water, and vacuum dried at 120° C. to give 48.52 g crude dichlorophthalic imide at a yield of 92%. The crude product was recrystallized with a mixed solvent of toluene and N,N-dimethylacetamide (4:1, v/v) for use in subsequent polymerization. In argon atmosphere, 7.9107 g (0.015 mol) of the above dichloromonomer, 0.4800 g (0.015 mol) sulfur, 1.3241 g (0.035 mol) sodium borohydride, 1.7954 g (0.032 mol) potassium hydroxide, 0.4439 g (0.004 mol) calcium chloride and 150 ml N,N-dimethylacetamide were added into a 500 ml three-necked flask which was dry and clean. The reactants were heated to 150° C. under agitation and allowed to react for 8 hours. The reaction solution was cooled to room temperature, transferred slowly into 2 L water and agitated for 12 hours. After filtration, the resultant filter cake was washed three times with distilled water, and then extracted with 95% ethanol for 24 hours. After vacuum drying at 120° C., 6.89 g polyimide was obtained as white powder at a yield of 94%. IR (KBr): 2935, 1785, 1720, 1609, 1385, 728 cm⁻¹. The logarithmic viscosity number was determined to be 1.26 dL/g in 0.5 g/dL m-cresol at 30° C. The weight average molecular weight and the polydispersity with respect to polystyrene standard were determined to be 88000 and 3.4 respectively by gel permeation chromatography. The glass transition temperature was determined to be 275° C. by differential scanning calorimetry (DSC). The viscosity was determined to be 60000 P at a temperature of 380° C. and at a speed of 1000 S⁻¹ using Physica MCR-301 rotational rheometer. The film tensile strength and the break elongation were determined to be 126 MPa and 9% respectively using a mechanical tensile tester.

### Example 7

Into a 500 ml three-necked flask, dry and clean, were added 91.28 g (0.50 mol) 4-chlorophthalic anhydride, 91.28 g (0.50 mol) 3-chlorophthalic anhydride and 100.12 g (0.5 mol) 4,4′-diaminodiphenyl ether. They were heated slowly under vacuum to 260° C. until a homogenous melt was obtained, and then allowed to react for 4 hours under agitation. After cooled to room temperature, 259.38 g crude dichlorophthalic imide was obtained at a yield of 98%. The crude product was used in subsequent polymerization as it was. Into a 500 ml three-necked flask, dry and clean, were added 10.5872 g (0.020 mol) of the above dichloromonomer, 0.6602 g (0.0206 mol) sulfur, 0.9600 g (0.04 mol) sodium hydride, 2.8471 g (0.0206 mol) potassium carbonate, 0.2120 g (0.005 mol) lithium chloride and 180 ml N-methylpyrrolidone. The reactants were heated to 80° C. under agitation and allowed to react for 24 hours, and then 0.3092 g (0.0012 mol) N-phenyl-3-chlorophthalic imide was added and allowed to react for 4 hours. The reaction solution was cooled to room temperature, transferred slowly into 2 L water and agitated for 12 hours. After filtration, the resultant filter cake was washed three times with distilled water, and then extracted with 95% ethanol for 24 hours. After vacuum drying at 120° C., 9.26 g polyimide was obtained as yellowish powder at a yield of 92%. IR (KBr): 2925, 1783, 1718, 1601, 1384, 725 cm⁻¹. The logarithmic viscosity number was determined to be 0.88 dL/g in 0.5 g/dL m-cresol at 30° C. The weight average molecular weight and the polydispersity with respect to polystyrene standard were determined to be 62000 and 3.8 respectively by gel permeation chromatography. The glass transition temperature was determined to be 272° C. by differential scanning calorimetry (DSC). The viscosity was determined to be 8000 P at a temperature of 380° C. and at a speed of 1000 S⁻¹ using Physica MCR-301 rotational rheometer. The film tensile strength and the break elongation were determined to be 119 MPa and 16% respectively using a mechanical tensile tester.

### Example 8

Into a 3 L three-necked flask, dry and clean, were added 28.97 g (0.15 mol) 4-nitrophthalic anhydride, 9.65 g (0.05 mol) 3-nitrophthalic anhydride and 1500 ml xylene, and after they were dissolved under agitation, 19.83 g (0.10 mol) 4,4′-diaminodiphenyl methane was added. The reactants were heated to 160° C. and allowed to react for 15 hours under reflux. The reaction solution was cooled to room temperature. After filtration, a filter cake was obtained, washed three times with distilled water, and vacuum dried at 120° C. to give 48.82 g crude dinitrophthalic imide at a yield of 89%. The crude product was recrystallized with a mixed solvent of toluene and N,N-dimethylformamide (4:1, v/v) for use in subsequent polymerization. In nitrogen atmosphere, 16.4520 g (0.030 mol) of the above dinitromonomer, 0.9618 g (0.030 mol) sulfur, 0.9909 g (0.030 mol) hydroxylamine, 2.0732 g (0.015 mol) potassium carbonate, 0.0424 g (0.001 mol) lithium chloride and 300 ml dimethylsulfoxide were added into a 1 L three-necked flask which was dry and clean. The reactants were heated to 110° C. under agitation and allowed to react for 8 hours. The reaction solution was concentrated to about 100 ml, transferred slowly into 1000 ml distilled water and agitated for 12 hours. After filtration, the resultant filter cake was washed three times with distilled water, and then extracted with 95% ethanol for 24 hours. After vacuum drying at 120° C., 13.92 g polyimide was obtained as white powder at a yield of 94%. IR (KBr): 2960, 1788, 1721, 1605, 1383, 721 cm⁻¹. The logarithmic viscosity number was determined to be 0.59 dL/g in 0.5 g/dL m-cresol at 30° C. The weight average molecular weight and the polydispersity with respect to polystyrene standard were determined to be 36000 and 2.8 respectively by gel permeation chromatography. The glass transition temperature was determined to be 278° C. by differential scanning calorimetry (DSC). The viscosity was determined to be 6000 P at a temperature of 380° C. and at a speed of 1000 S⁻¹ using Physica MCR-301 rotational rheometer. The film tensile strength and the break elongation were determined to be 106 MPa and 10% respectively using a mechanical tensile tester.

### Example 9

Into a 2 L three-necked flask, dry and clean, were added 38.62 g (0.20 mol) 4-nitrophthalic anhydride, 38.62 g (0.20 mol) 3-nitrophthalic anhydride and 800 ml N,N-dimethylacetamide, and after they were dissolved under agitation, 42.45 g (0.20 mol) 4,4′-diaminobenzophenone was added. The reactants were heated to 170° C. and allowed to react for 15 hours under reflux. The reaction solution was cooled to room temperature. After filtration, a filter cake was obtained, washed three times with anhydrous ethanol, and vacuum dried at 120° C. to give 106.87 g crude dinitrophthalic imide at a yield of 95%. The crude product was recrystallized with a mixed solvent of toluene and N,N-dimethylformamide (2:1, v/v) for use in subsequent polymerization. In argon atmosphere, 8.4371 g (0.015 mol) of the above dinitromonomer, 0.4905 g (0.0153 mol) sulfur, 1.3241 g (0.035 mol) sodium borohydride, 1.7955 g (0.032 mol) potassium hydroxide, 0.7495 g (0.005 mol) sodium iodide, 120 ml N,N-dimethylacetamide and 15 ml xylene were added into a 500 ml three-necked flask which was dry and clean. The reactants were heated to 150° C. under agitation and allowed to react for 16 hours. The reaction solution was concentrated to about 100 ml, transferred slowly into 1000 ml distilled water and agitated for 12 hours. After filtration, the resultant filter cake was washed three times with distilled water, and then extracted with 95% ethanol for 24 hours. After vacuum drying at 120° C., 7.24 g polyimide was obtained as yellowish powder at a yield of 96%. IR (KBr): 3060, 1670, 1784, 1718, 1600, 1388, 718 cm⁻¹. The logarithmic viscosity number was determined to be 0.68 dL/g in 0.5 g/dL m-cresol at 30° C. The weight average molecular weight and the polydispersity with respect to polystyrene standard were determined to be 42000 and 3.1 respectively by gel permeation chromatography. The glass transition temperature was determined to be 288° C. by differential scanning calorimetry (DSC). The viscosity was determined to be 6800 P at a temperature of 380° C. and at a speed of 1000 S⁻¹ using Physica MCR-301 rotational rheometer. The film tensile strength and the break elongation were determined to be 136 MPa and 17% respectively using a mechanical tensile tester.

### Example 10

Into a 3 L three-necked flask, dry and clean, were added 115.87 g (0.60 mol) 4-nitrophthalic anhydride, 77.24 g (0.40 mol) 3-nitrophthalic anhydride and 1800 ml glacial acetic acid, and after they were dissolved under agitation, 113.16 g (0.50 mol) 3,3′-dimethyl-4,4′-diaminodiphenyl methane was added. The reactants were heated to 130° C. and allowed to react for 24 hours under reflux. The reaction solution was cooled to room temperature, transferred into 8 L distilled water and agitated for 3 hours. After filtration, a filter cake was obtained, washed three times with distilled water, and vacuum dried at 120° C. to give 265.21 g crude dinitrophthalic imide at a yield of 92%. The crude product was vacuum melted for use in subsequent polymerization. Into a 100 ml three-necked flask, dry and clean, were added 2.8827 g (0.005 mol) of the above dinitromonomer, 0.1664 g (0.0052 mol) sulfur, 0.5518 g (0.0052 mol) benzaldehyde, 0.5511 g (0.0052 mol) sodium carbonate, 1.3318 g (0.012 mol) calcium chloride, 0.1053 g (0.0004 mol) 3-nitrodiphenyl sulfone and 50 ml N-methylpyrrolidone. The reactants were heated to 140° C. under agitation and allowed to react for 10 hours. The reaction solution was cooled to room temperature, transferred slowly into 500 ml distilled water and agitated for 12 hours. After filtration, the resultant filter cake was washed three times with distilled water, and then extracted with 95% ethanol for 24 hours. After vacuum drying at 120° C., 2.39 g polyimide was obtained as white powder at a yield of 89%. IR (KBr): 2928, 1782, 1724, 1603, 1381, 725 cm⁻¹. The logarithmic viscosity number was determined to be 1.20 dL/g in 0.5 g/dL m-cresol at 30° C. The weight average molecular weight and the polydispersity with respect to polystyrene standard were determined to be 72000 and 3.9 respectively by gel permeation chromatography. The glass transition temperature was determined to be 264° C. by differential scanning calorimetry (DSC). The film tensile strength and the break elongation were determined to be 128 MPa and 13% respectively using a mechanical tensile tester.

### Example 11

Into a 2 L three-necked flask, dry and clean, were added 18.26 g (0.10 mol) 4-chlorophthalic anhydride, 91.28 g (0.50 mol) 3-chlorophthalic anhydride and 1000 ml glacial acetic acid, and after they were dissolved under agitation, 76.31 g (0.30 mol) 2,2′,3,3′-tetramethyl-4,4′-diaminodiphenyl methane was added. The reactants were heated to 130° C. and allowed to react for 28 hours under reflux. The reaction solution was cooled to room temperature, transferred into 5 L distilled water and agitated for 3 hours. After filtration, a filter cake was obtained, washed three times with distilled water, and vacuum dried at 120° C. to give 161.04 g crude dichlorophthalic imide at a yield of 92%. The crude product was recrystallized with a mixed solvent of toluene and N,N-dimethylformamide (2:1, v/v) for use in subsequent polymerization. In nitrogen atmosphere, 2.9175 g (0.005 mol) of the above dichloromonomer, 0.1600 g (0.005 mol) sulfur, 0.6700 g (0.005 mol) sodium oxalate, 1.0600 g (0.010 mol) sodium carbonate, 0.0424 g (0.001 mol) lithium chloride and 60 ml tetramethylene sulfone were added into a 100 ml three-necked flask which was dry and clean. The reactants were heated to 180° C. under agitation and allowed to react for 24 hours. The reaction solution was cooled to room temperature, transferred slowly into 500 ml methanol and agitated for 12 hours. After filtration, the resultant filter cake was washed three times with distilled water, and then extracted with 95% ethanol for 24 hours. After vacuum drying at 120° C., 2.43 g polyimide was obtained as white powder at a yield of 93%. IR (KBr): 2940, 1786, 1721, 1608, 1380, 726 cm⁻¹. The logarithmic viscosity number was determined to be 1.73 dL/g in 0.5 g/dL m-cresol at 30° C. The weight average molecular weight and the polydispersity with respect to polystyrene standard were determined to be 135000 and 4.4 respectively by gel permeation chromatography. The glass transition temperature was determined to be 292° C. by differential scanning calorimetry (DSC). The film tensile strength and the break elongation were determined to be 133 MPa and 9% respectively using a mechanical tensile tester.

1. A polythioetherimide, wherein the polythioetherimide has a structure of formula I: 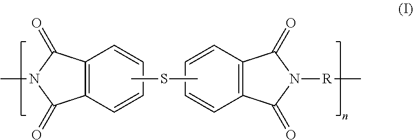
wherein thioether bond is located at 3-position or 4-position;
R is a substituted or unsubstituted organic group.

2. A method for preparing a polythioetherimide, wherein chlorophthalic anhydride or nitrophthalic anhydride isomer of formula II is used as the starting material to react with half molar equivalent of a disubstituted amine NH₂RNH₂ to give a disubstituted phthalic imide which further couples with about equal molar equivalent of an alkali metal sulfide to give a polythioetherimide resin of formula I as shown above, 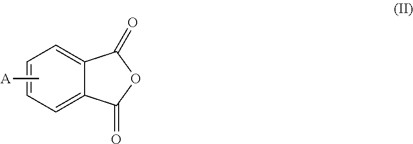
wherein substitute A is chlorine or nitro at 3- or 4-position.

3. The preparation method of claim 2, wherein the molar ratio of 3-substituted phthalic anhydride to 4-substituted phthalic anhydride in the starting material, i.e. chlorophthalic anhydride or nitrophthalic anhydride, is in the range between about 99.9:0.1 and about 0.1:99.9.

4. The preparation method of claim 2, wherein the preparation method is carried out in two steps, wherein the first step involves the reaction between the chlorophthalic anhydride or nitrophthalic anhydride isomer and half molar equivalent of a disubstituted amine NH₂RNH₂ in a polar non-protonic solvent, or in glacial acetic acid under reflux, or in a mixture of a benzene-type solvent and a polar non-protonic solvent under reflux, at a temperature ranging from 100° C. to 200° C., most preferably from 110° C. to 180° C.; and the second step involves the coupling reaction of the resultant disubstituted phthalic imide with equal molar equivalent of an alkali metal sulfide in a polar non-protonic solvent, or in a mixture of a benzene type solvent and a polar non-protonic solvent, in the presence or absence of an optional catalyst such as sodium hydroxide, potassium hydroxide, anhydrous sodium carbonate, anhydrous potassium carbonate or anhydrous lithium chloride, at a temperature ranging from 80° C. to 220° C., most preferably from 100° C. to 170° C.

5. The preparation method of claim 4, wherein the polar non-protonic solvent is N,N′-dimethyl formamide (DMF), N,N′-dimethyl acetamide (DMAc), N-methyl-2-pyrrolidone (NMP), dimethyl sulfoxide (DMSO), hexamethylphosphoramide (HMPA) or tetramethylene sulfone.

6. The preparation method of claim 4, wherein the benzene type solvent is selected from benzene, toluene, xylene or chlorobenzene.

7. The preparation method of claim 4, wherein the alkali metal sulfide is anhydrous lithium sulfide, potassium sulfide or sodium sulfide; and preferably, the alkali metal sulfide is prepared via one of the following two methods:
(i) reacting an alkali metal with sulfur;
(ii) purifying an industrial grade alkali metal sulfide, particularly sodium sulfide, by heating at high vacuum, or by azeotropic reflux with a benzene type solvent such as benzene, toluene, xylene or chlorobenzene to remove water, or by recrystallization.

8. The preparation method of claim 4, wherein the organic group R is a substituted or unsubstituted aliphatic or aromatic diamine, particularly, the organic group R is selected from the group consisting of 1,6-hexamethylene diamine, 1,6-cyclohexanediamine, p-phenylene diamine, m-phenylene diamine, 4,4′-biphenylene diamine, 3,3′-dimethyl-4,4′-biphenylene diamine, 2,2′-dimethyl-4,4′-biphenylene diamine, 4,4′-diaminodiphenyl ether, 3,4′-diaminodiphenyl ether, 4,4′-diaminobenzophenone, 3,4′-diaminobenzophenone, 4,4′-diaminodiphenyl sulfone, 3,4′-diaminodiphenyl sulfone, 4,4′-diaminodiphenyl methane, 4,4′-diaminodiphenyl isopropane, 4,4′-diaminodiphenyl thioether, 2,2′-dichloro-4,4′-diaminodiphenyl methane, 3,3′-dichloro-4,4′-diaminodiphenyl methane, 4,4′-diaminodiphenoxyl-4″,4′″-biphenyl, 4,4′-diaminodiphenoxyl-4″,4′″-diphenyl ether, 4,4′-diaminodiphenoxyl-4″,4′″-diphenyl sulfone, 4,4′-diaminodiphenoxyl-4″,4′″-diphenyl isopropane, 2,4-toluene diamine, 5-methyl-4,6-diethyl-1,3-phenylene diamine, 3,3′-dimethyl-4,4′-diaminodiphenyl methane, or 2,2′, 3,3′-tetramethyl-4,4′-diaminodiphenyl methane, or mixtures thereof.

9. The preparation method of claim 4, wherein,
using at least one chain end-capping agent for polymerization to control the polymerization degree and the molecular weight of the final polymer during the coupling reaction of the disubstituted phthalic imide with the alkali metal sulfide.

10. The preparation method of claim 9, wherein the chain end-capping agent is an aromatic compound of formula III,
B—Ar-M III
wherein B is selected from but not limited to halogen atoms such as fluorine, chlorine or bromine, or nitro group; Ar is a substituted or unsubstituted aromatic group which may be selected from but not limited to one of the following: phenyl, substituted phenyl, biphenyl, substituted biphenyl, furanyl, pyridyl, naphthyl or quinolyl, etc.; M may be selected from but not limited to one of the following atoms or groups: for example, hydrogen, methyl, acyl, phenyl acyl, alkyl sulphonyl, aromatic sulphonyl, nitro, cyano, azo, carboxyl, trifluoromethyl, imido or substituted imido, etc.; and
preferably, the chain end-capping agent is 3-chlorophenyl-tert-butyl ketone, 3-fluorophenyl-tert-butyl ketone, 4-chlorobenzophenone, 3-nitrobenzophenone, 4-nitrophenyl methyl sulfone, 4-fluorophenyl phenyl sulfone, 2-iodonitrobenzene, 4-bromophenyl azobenzene, 4-fluoropyridine, 3-chlorobenzoic acid, 1-nitro-4-trifluoromethyl benzene, 1-chloro-3-trifluoromethyl benzene, N-phenyl-3-chlorophthalic imide, N-phenyl-4-fluorophthalic imide, N-methyl-3-chlorophthalic imide, N-methyl-4-nitrophthalic imide, N-butyl-3-chlorophthalic imide, or N-cyclohexyl-4-chlorophthalic imide, or mixtures of two or more thereof, wherein the most preferred molar amount of the chain end-capping agent used is about 0.01-0.15 times that of the corresponding disubstituted phthalic imide.

11. A method for preparing a polythioetherimide, wherein chlorophthalic anhydride or nitrophthalic anhydride of the above formula II is used as the starting material to react with half molar equivalent of an organic diamine NH₂RNH₂ to give a disubstituted phthalic imide which further couples with about equal molar equivalent of sulfur to give a polythioetherimide resin of formula I as shown above.

12. The preparation method of claim 11, wherein the molar ratio of 3-substituted phthalic anhydride to 4-substituted phthalic anhydride in the starting material, i.e. chlorophthalic anhydride or nitrophthalic anhydride, is in any range between about 99.9:0.1 and about 0.1:99.9.

13. The preparation method of claim 11, wherein the preparation method is carried out in two steps, wherein the first step involves the reaction between isomeric chlorophthalic anhydride or nitrophthalic anhydride and half molar equivalent of an organic diamine in a polar non-protonic solvent, or in glacial acetic acid under reflux, or in a mixture of a benzene type solvent and a polar non-protonic solvent under reflux, or in molten state under heating, at a temperature ranging from 100° C. to 350° C., most preferably from 120° C. to 280° C., to produce a disubstituted phthalic imide; and the second step involves the coupling reaction of the disubstituted phthalic imide with about equal molar equivalent of sulfur in a polar non-protonic solvent or in a mixture of a benzene-type solvent and a polar non-protonic solvent in the presence of a reductant, a catalyst and a reaction aid at a temperature ranging from 60° C. to 260° C., most preferably from 100° C. to 190° C., to produce polythioetherimide, wherein the molar amount of sulfur used is about 0.90-1.30 times, most preferably 0.95-1.15 times that of the corresponding disubstituted phthalic imide.

14. The preparation method of claim 13, wherein the polar non-protonic solvent is N,N-dimethyl formamide (DMF), N,N-dimethyl acetamide (DMAc), N-methyl-2-pyrrolidone (NMP), dimethyl sulfoxide (DMSO), hexamethylphosphoramide (HMPA), diphenyl sulfone or tetramethylene sulfone.

15. The preparation method of claim 13, wherein the benzene type solvent is selected from benzene, toluene, xylene or chlorobenzene.

16. The preparation method of claim 13, wherein the organic group R is a substituted or unsubstituted aliphatic or aromatic diamine which may be selected from but not limited to, for example, at least one of the following: 1,2-hexanediamine, 1,6-hexamethylene diamine, 1,6-cyclohexanediamine, p-phenylene diamine, m-phenylene diamine, 4,4′-biphenylene diamine, 3,3′-dimethyl-4,4′-biphenylene diamine, 2,2′-dimethyl-4,4′-biphenylene diamine, 4,4′-diaminodiphenyl ether, 3,4′-diaminodiphenyl ether, 4,4′-diaminobenzophenone, 3,4′-diaminobenzophenone, 4,4′-diaminodiphenyl sulfone, 3,4′-diaminodiphenyl sulfone, 4,4′-diaminodiphenyl methane, 4,4′-diaminodiphenyl isopropane, 4,4′-diaminodiphenyl thioether, 2,2′-dichloro-4,4′-diamino diphenyl methane, 3,3′-dichloro-4,4′-diaminodiphenyl methane, 4,4′-diaminodiphenoxyl-4″,4′″-biphenyl, 4,4′-diaminodiphenoxyl-4″,4′″-diphenyl ether, 4,4′-diaminodiphenoxyl-4″,4′″-diphenyl sulfone, 4,4′-diaminodiphenoxyl-4″,4′″-diphenyl isopropane, 2,4-toluene diamine, 5-methyl-4,6-diethyl-1,3-phenylene diamine, 3,3′-dimethyl-4,4′-diaminodiphenyl methane, or 2,2′, 3,3′-tetramethyl-4,4′-diaminodiphenyl methane, or mixtures thereof.

17. The preparation method of claim 13, wherein the reductant for the coupling of the disubstituted phthalic imide with sulfur may be selected from but not limited to at least one of the following: formates (such as sodium formate, potassium formate or lithium formate), oxalates (such as sodium oxalate, potassium oxalate or lithium oxalate), aldehydes (such as formaldehyde or acetaldehyde), hydrazines (such as phenylhydrazine or hydrated hydrazine), hydroxylamine, elemental metal (such as iron powder, aluminum powder or zinc powder), hydrides (such as sodium hydride, calcium hydride, sodium borohydride or lithium aluminum hydride), ammonia, hydrogen and the like, or mixtures thereof; and the molar amount of the reductant used is 0.2-6 times, most preferably 0.4-3 times that of sulfur.

18. The preparation method of claim 13, wherein the aid and the catalyst for the coupling reaction of the disubstituted phthalic imide with sulfur may be selected from but not limited to at least one of the following: carbonates such as lithium carbonate, sodium carbonate or potassium carbonate, hydrocarbonates such as sodium hydrocarbonate or potassium hydrocarbonate, phosphates such as sodium hydrophosphate or potassium hydrophosphate, hydrophosphates such as dibasic sodium phosphate or dibasic potassium phosphate, basic hydroxides such as potassium hydroxide, sodium hydroxide or lithium hydroxide, halides such as calcium chloride, sodium chloride, potassium chloride, lithium bromide, potassium fluoride or sodium iodide, or mixtures thereof; and
the molar amount of the aid and the catalyst used is 0.02-3 times, most preferably 0.05-1.5 times that of sulfur.

19. The preparation method of claim 13, wherein the coupling polymerization of the disubstituted phthalic imide with sulfur is carried out in inert atmosphere which may be selected from but not limited to nitrogen or argon.

20. The preparation method of claim 13, wherein, using at least one chain end-capping agent for polymerization to control the polymerization degree and the molecular weight of the final polymer during the coupling reaction of the disubstituted phthalic imide and sulfur.

21. The preparation method of claim 20, wherein the chain end-capping agent is an aromatic compound of formula III,
B—Ar-M III
wherein B may be selected from but not limited to halogen atoms such as fluorine, chlorine or bromine, or nitro, etc.; Ar is a substituted or unsubstituted aromatic group which may be selected from but not limited to one of the following: phenyl, substituted phenyl, biphenyl, substituted biphenyl, furanyl, pyridyl, naphthyl or quinolyl; M may be selected from but not limited to one of the following atoms or groups: for example, hydrogen, methyl, acyl, phenyl acyl, alkyl sulphonyl, aromatic sulphonyl, nitro, cyano, azo, carboxyl, trifluoromethyl, imido or substituted imido; and
preferably, the chain end-capping agent is 3-chlorophenyl-tert-butyl ketone, 3-fluorophenyl-tert-butyl ketone, 4-chlorobenzophenone, 3-nitrobenzophenone, 4-nitrophenyl methyl sulfone, 4-fluorophenyl phenyl sulfone, 2-iodonitrobenzene, 4-bromophenyl azobenzene, 4-fluoropyridine, 3-chlorobenzoic acid, 1-nitro-4-trifluoromethyl benzene, 1-chloro-3-trifluoromethyl benzene, N-phenyl-3-chlorophthalic imide, N-phenyl-4-fluorophthalic imide, N-methyl-3-chlorophthalic imide, N-methyl-4-nitrophthalic imide, N-butyl-3-chlorophthalic imide, or N-cyclohexyl-4-chlorophthalic imide, etc., or mixtures of two or more thereof, wherein the most preferred molar amount of the chain end-capping agent used is about 0.01-0.15 times that of the corresponding disubstituted phthalic imide.

22. The preparation method of claim 2, wherein the polythioetherimide has a logarithmic viscosity number of about 0.13 dL/g to about 1.90 dL/g as measured in 0.5 g/dL m-cresol at 30° C. using Ubbelohde viscometer.

23. The preparation method of claim 2, wherein the polythioetherimide has a weight average molecular weight of about 3000 to about 200000 and a polydispersity of about 1.8-about 5.4 with respect to polystyrene standard as measured by gel permeation chromatography.

24. The preparation method of claim 2, wherein the polythioetherimide has a glass transition temperature of about 200° C.-about 350° C. according to reheating data as measured by differential scanning calorimetry (DSC) using Perkin Elmer Diamond DSC in nitrogen atmosphere at a heating rate of 20° C./min.

25. The preparation method of claim 2, wherein the polythioetherimide has a viscosity of about 500 P-about 100000 P as measured at a temperature of 380° C. and at a speed of 1000 S⁻¹ using Physica MCR-301 rotational rheometer.

26. The preparation method of claim 2, wherein the polythioetherimide has a film tensile strength of about 60 MPa-about 200 MPa and a break elongation of about 5%-about 40% as measured at room temperature and at a speed of 5 mm/min using Instron Model 5567 mechanical tensile tester.
